(19) United States
(12) Patent Application Publication
(10) Pub. No.: US 2019/0183717 A1
(43) Pub. Date: Jun. 20, 2019

(54) FRAME CONFIGURATIONS FOR MOBILITY AID DEVICES

(71) Applicant: Applied Mobility Devices, LLC, Estero, FL (US)

(72) Inventors: William Scott, Estero, FL (US); Joseph Cuiffi, Pittsburgh, PA (US)

(21) Appl. No.: 15/868,969

(22) Filed: Jan. 11, 2018

Related U.S. Application Data
(60) Provisional application No. 62/444,912, filed on Jan. 11, 2017.
(60) Provisional application No. 62/444,921, filed on Jan. 11, 2017.
(60) Provisional application No. 62/444,923, filed on Jan. 11, 2017.

(51) Int. Cl. A61H 3/02

(52) U.S. Cl. CPC A61H 3/02; A61H 2003/006; A61H 2003/0227; A61H 2003/0238

(57) ABSTRACT

Mobility aid devices, such as crutches, provide improved ergonomics, comfort and support for the user. The crutches can include a frame configuration where a main frame member includes a lower adjustment pole extending therefrom and a secondary pole is attached to a lower end of the main pole and extends upward therefrom. An axilla support may be supported by the main pole and the secondary pole. Typically, the axilla support may be supported by upper adjustment poles that adjustably telescope from the tops of the main pole and the secondary pole. The frame configuration, or a conventional frame, may be used in a crutch that can be convertible between a crutch, such as a cuff crutch, and a cane.

### CROSS-REFERENCE TO RELATED APPLICATIONS

This application claims the benefit of priority of U.S. provisional patent application No. 62/444,912, filed Jan. 11, 2017, U.S. provisional patent application No. 62/444,921, filed Jan. 11, 2017 and U.S. provisional patent application No. 62/444,923, filed Jan. 11, 2017, the contents of each of which are herein incorporated by reference.

### BACKGROUND OF THE INVENTION

### 1. Field of the Invention

One or more embodiments of the invention relates generally to mobility aid devices. More particularly, the invention relates to improvements to mobility aid devices regarding the frame support component. The invention further relates to a convertible device that can be used as a forearm support crutch or a cane.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

For all the extraordinary technological advances made in medical devices over the past half century, crutches (including axilla and forearm styles), and canes walking sticks, substitute crutches and leg/foot prosthesis, walkers have fallen dangerously behind. The basic design of standard crutches, canes and walkers hasn't changed for decades, going back to when the first medical advice given to new patients was “take it easy and go slow.”Unstable, uncomfortable, inflexible and unattractive at best, their design actually impedes a user's return to max-mobility potential. It also contributes to something most mobility device designers don't think about: the loss of dignity the user feels at having to rely on these archaic devices in the first place.

First, they're uncomfortable and fatiguing. This not only limits the time a patient is able to use them but also puts stress on the hands, wrists, forearms, neck and back, which can lead to upper back ailments and other physical disorders, such as rotator cuff tears.

Second, because they so poorly conform to the body's natural physiology, they're awkward to maneuver and thus inherently unstable. This especially applies to children where the majority of hospitals prescribe walkers instead of crutches to kids under age eleven because of this instability. Adolescents, the elderly, the overweight, the out-of-shape and/or those who have been prescribed painkillers or other medications are also affected-which covers just about all of us. The result is often a loss of balance and an awkward, nasty fall that can reinjure the patient or cause new trauma to the head, wrists, ankles and other areas of the body.

These devices have for years been associated with discomfort and instability. What hasn't been addressed up to now is their basic inflexible, “static” nature. That is, they've been designed to accommodate a patient at his/her initial (and therefore worst) point of pain and discomfort; they aren't designed to “adjust” as the user heals and desires greater mobility. This disadvantage actually retards the recovery of the user who's capable of moving more freely than the device will accommodate.

A user walking with crutches will take a minimum of 2,400 steps, with children taking closer to 3,000. The jarring staccato of each of these steps reverberating wave after wave of pain through though the crutches, further causes discomfort to the entire body however specifically irritates the hands, wrists, elbows, shoulder joints and upper back. These inadequacies no nothing to enhance healing and lead to accelerated fatigue.

Not to be overlooked, these stark, Spartan-like devices, which put users in slumped over, clumsy-looking positions, almost seem purposely designed to make the user feel self-conscious and even stigmatized. Nothing about how they look-nor how they make the tottering user look when trying to stay upright-lends dignity to the patient.

Over recent years, however, medical professionals have learned that the key to rapid recovery from surgery, injury or any incident impacting mobility is to get patients up and walking as naturally as their pain will allow, as quickly as possible. Put it all together and medical professionals who must prescribe the use of these particular mobility aids actually find themselves unintentionally violating their sacred oath “to do no harm.”

In view of the foregoing, there is a need for an improved mobility aid device that addresses various design flaws found in conventional mobility aids.

### SUMMARY OF THE INVENTION

Embodiments of the present invention provide an adjustable crutch frame comprising a main pole having a lower adjustment pole receptacle; a secondary pole attached to and extending from the main pole; and a lower pole telescopingly extending from the main pole.

In some embodiments, the main pole and the secondary pole extend upward at an angle between about 1 degree to about 3 degrees from vertical.

In some embodiments, the adjustable crutch frame has an adjustment range that provides for from about 18 inches to about 24 inches of length adjustment.

In some embodiments, the adjustable crutch frame further includes upper adjustment pole receptacles on a top end of the main pole and the secondary pole.

In some embodiments, the adjustable crutch frame further includes upper adjustment poles telescopingly extending from the upper adjustment poles.

In some embodiments, the adjustable crutch frame further includes a handgrip placed on at least one of the main pole and the secondary pole, the handgrip serving as a handle for a user moving between a standing position and a seated position.

In some embodiments, the adjustable crutch frame further includes at least one strap for securing a pair of the adjustable crutch frames together.

Embodiments of the present invention further provide an adjustable crutch frame comprising a main pole having a lower adjustment pole receptacle and an upper adjustment pole receptacle; a secondary pole attached to and extending from the main pole, the secondary pole having a secondary pole upper adjustment pole receptacle; a lower pole telescopingly extending from the main pole; and upper adjustment poles telescopingly extending from each of the upper adjustment pole receptacle and the secondary pole upper adjustment pole receptacle.

Embodiments of the present invention also provide a mobility aid device that converts between a forearm cuff crutch and a cane comprising a cuff support apparatus having a cuff and a cuff support extending from the cuff; a main pole providing an attachment point for removably attaching the cuff support, the main pole further having a lower receptacle; a foot pole telescopingly extending from the lower receptacle of the main pole; and a grip attached to the main pole.

In some embodiments, the convertible device includes a secondary pole having a first end attaching to the main pole and a second end attaching to the grip.

In some embodiments, the convertible device includes a grip that is an ergonomically shaped grip.

In some embodiments, the convertible device includes a foot attached to a distal end of the foot pole, wherein the foot articulates, allowing for rotation thereof.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a side view of a conventional crutch device;

FIG. 2 is a side view of a crutch device utilizing a frame configuration according to an exemplary embodiment of the present invention;

FIG. 3 is a side view of a crutch device utilizing the frame configuration of FIG. 2, illustrating additional optional features thereof;

FIG. 4 is a perspective view of a cuff crutch utilizing the frame configuration of FIG. 2; and

FIG. 5 is a perspective view of a cane style mobility aid device that can be formed from converting the cuff crutch of FIG. 4.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide mobility aid devices, such as crutches, canes, or the like, that provide improved ergonomics, comfort and support for the user. The mobility aid devices can include a frame configuration where a main frame member includes a lower adjustment pole extending therefrom and a secondary pole is attached to a lower end of the main pole and extends upward therefrom. An axilla support may be supported by the main pole and the secondary pole. Typically, the axilla support may be supported by upper adjustment poles that adjustably telescope from the tops of the main pole and the secondary pole. The frame configuration, or a conventional frame, may be used in a crutch that can be convertible between a crutch, such as a cuff crutch, and a cane.

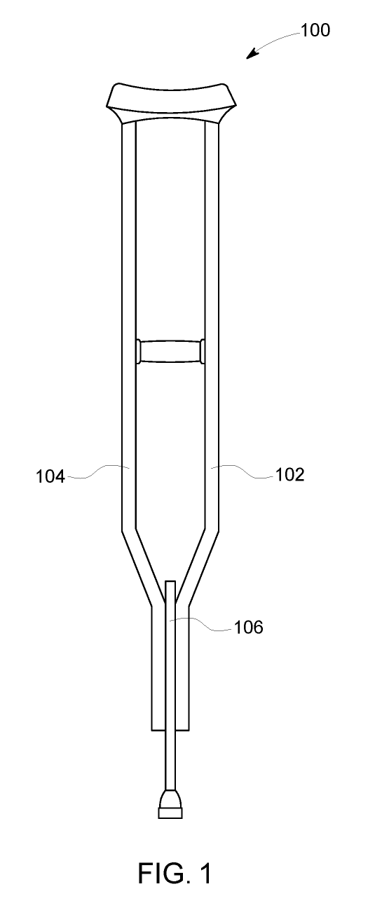

Axilla-style crutches, ones with an upper support that fits under the user's armpit area, vary in style, but have a typical frame design 100 shown in FIG. 1, including two side poles 102, 104 that are essentially mirror images thereof, with a main pole 106 adjustably attached to the side poles 102, 104. As discussed below, the crutch frame design according to embodiments of the present invention improves strength and stability as compared to conventional crutches, while offering additional components for convenience.

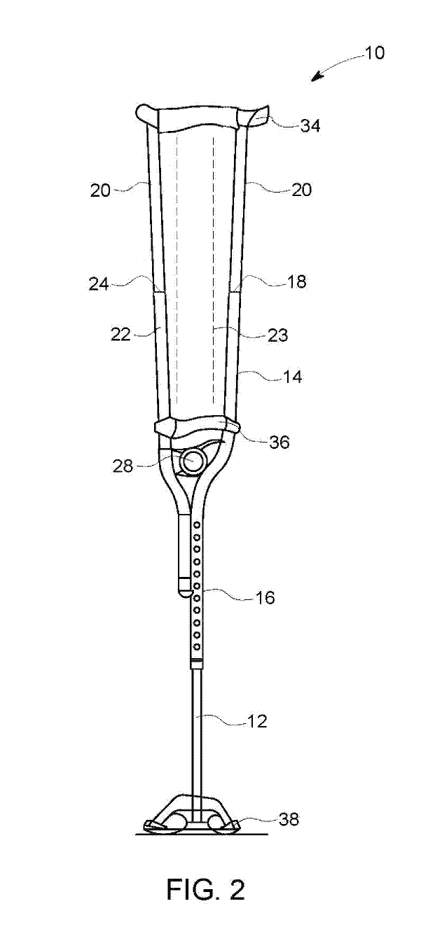

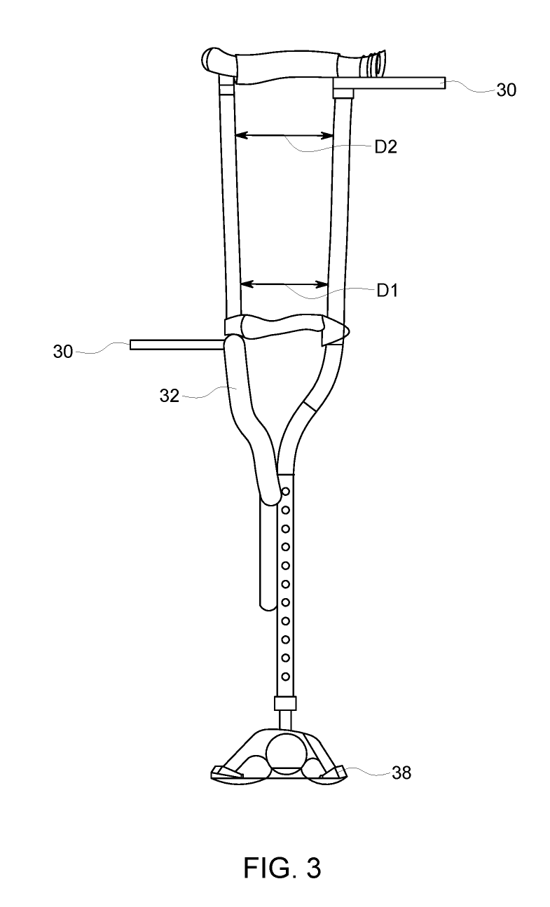

Referring to FIGS. 2 and 3, schematic exemplary frame configurations 10 according to embodiments of the present invention are shown. As can be immediately appreciated, the frame configuration 10 is an adjustable design with five pole components, as described in greater detail below. Conventional adjustable crutches have at least six pole components. The reduced number of poles not only improves manufacturability but also improves strength because of a reduced number of connectors or rivets. This occurs because the typically independent lower adjustment or foot pole 12 is now part of the main pole 14 in the improved frame configuration 10. The main pole 14 of the frame configuration 10 includes a lower adjustment pole receptacle 16 for the foot pole 12 and an upper adjustment pole receptacle 18 for one of the upper adjustment poles 20. A secondary pole 22 may extend from an attachment point with the main pole 14 upward to terminate at an upper adjustment pole receptacle 24 for one of the upper adjustment poles 20. The upper adjustment poles 20 may adjustably support an axilla support 34 therefrom. In some embodiments, the axilla support 34 may be fixed on the main pole 14 and the secondary pole 22 (without the upper adjustment poles 20) and a grip 36 may be adjustably disposed between the main pole 14 and the secondary pole 22.

The adjustment of the foot pole 12 and the upper adjustment poles 20 may be performed by various mechanisms as known in the art, such as by using pushbuttons or other similar mechanisms. The adjustments allow for an adjustment range of, for example, between about 18 inches to about 24 inches, depending on main and secondary pole dimensions.

As can be seen in FIG. 2, the upper part of the frame configuration 10 is not vertical. Dotted lines 22 illustrate a vertical pole design, as is used in conventional adjustable crutches. According to embodiments of the present invention, the upper adjustment poles 20, along with the main pole 14 and a secondary pole 22 are each angled outward by about two degrees from vertical. This minor adjustment is significant in that it increases the distance between the upper adjustment poles 20 at the top of the crutch, which results in a more stable feel to the user. In other words, as shown in FIG. 3, D2>D1. The pole positions that are widened at the top further help to stabilize the overall structure for balance and load. Although the poles are angled, the adjustments are still enabled due to minor flexing in the frame during adjustment, for example.

In some embodiments, a placard 28 for the display of logos and other images may be disposed between the main pole 14 and the secondary pole 22. This is an improvement designed to permit users to display their logo on the crutch design 10, improving marketability.

Referring to FIG. 3, two other optional improvements to the crutch configuration 10 are shown. A set of straps 30 can be used to hold a pair of crutches together. In some embodiments, a hook and loop type strap can be used that simply wraps around the other frame in a pair of crutches to hold them together. This improvement prevents the annoying falling of crutches when leaned against a wall or other structure and assists when carrying the crutch set. In some embodiments, a grip pad 32 is added to one or both of the poles 14, 22 to provide a grip when standing from a seated position. This is a helpful aid shown during testing with potential users. The grip feature is also described and illustrated in commonly-owned, concurrently filed U.S. patent application Ser. No. ______, entitled “Dynamic Foot Support for Walking Aid Devices”, the contents of which are herein incorporated by reference.

Moreover, the axilla support 34 and grip 36 shown may be formed in various designs and configurations. In some embodiments, the axilla support 34 and grip 36 may be configured similar to those described in commonly-owned, concurrently filed U.S. patent application Ser. No. ______, entitled “Ergonomic Grip and Axilla for Walking Aid Devices”, the contents of which are herein incorporated by reference. Similarly, the foot 38 shown may be formed in various designs and configurations. In some embodiments, the foot 38 may be configured similar to those described in commonly-owned, concurrently filed U.S. patent application Ser. No. ______, entitled “Dynamic Foot Support for Walking Aid Devices”, the contents of which are herein incorporated by reference.

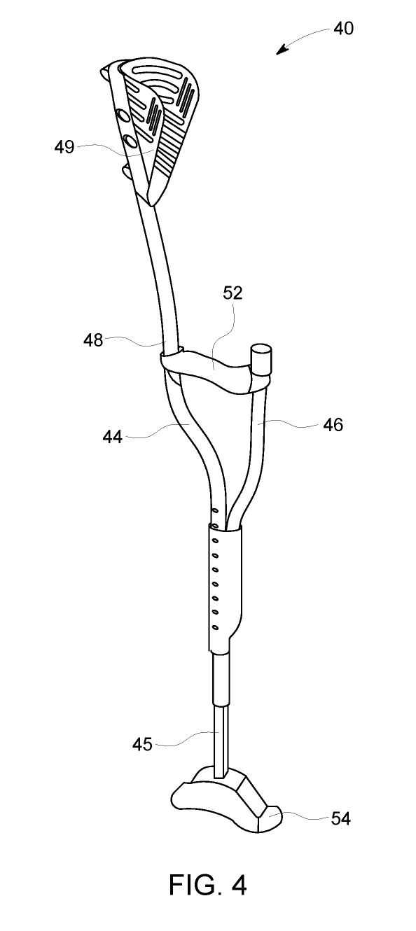

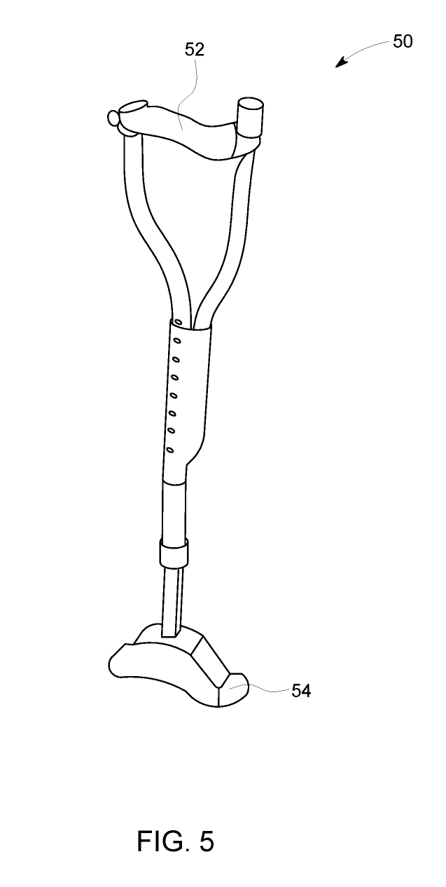

Referring now to FIGS. 4 and 5, typical mobility aid devices, such as an axilla crutches, forearm cuff crutches and walking canes, are singular devices. The convertible device according to embodiments of the present invention allows for use as a forearm cuff crutch 40 or a cane 50, allowing the user to determine the level of support needed.

In the cuff crutch 40, a cuff 42 that supports the forearm can be removed, for example, by a pushbutton or other mechanism, to convert the cuff crutch 40 in to a walking cane 50. This allows users to determine the level of support and comfort during recovery or in different situations without having to carry two devices.

The cuff crutch 40 may include a frame configuration similar to that illustrated in FIGS. 2 and 3, where a main pole 44 acts as an attachment point 48 for the cuff support 49, which may be designed, as known in the art, to be adjustable in length. In some embodiments, the cuff support 49 may support the forearm (not shown) of the user, as shown in FIG. 4, or may wrap about the user's forearm, where the user inserts their forearm through the cuff. In some embodiments, the cuff may convert between these two cuff styles. The main pole 44 can also act as a receptacle for a foot pole 45, which may be adjustably attached to the main pole 44 in, for example, a telescoping arrangement. A secondary pole 46 can be used to provide strength and support for the grip 52 and avoids the use of a heavy grip mounting mechanism. In some embodiments, the secondary pole 46 may be omitted, where the grip 52 may be supported only by the main pole 44.

Moreover, the grip 52 shown may be formed in various designs and configurations. In some embodiments, the grip 52 may be configured similar to those described in commonly-owned, concurrently filed U.S. patent application Ser. No. ______, entitled “Ergonomic Grip and Axilla for Walking Aid Devices”, the contents of which are herein incorporated by reference. Similarly, the foot 54 shown may be formed in various designs and configurations. In some embodiments, the foot 54 may be configured similar to those described in commonly-owned, concurrently filed U.S. patent application Ser. No. ______, entitled “Dynamic Foot Support for Walking Aid Devices”, the contents of which are herein incorporated by reference.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. An adjustable crutch frame comprising:
a main pole having a lower adjustment pole receptacle;
a secondary pole attached to and extending from the main pole;
a grip disposed between the main pole and the secondary pole; and
a lower pole telescopingly extending from the main pole, wherein
the main pole extends linearly upward from the grip at an angle outward relative a vertical axis extending through the grip.

2. The adjustable crutch frame of claim 1, wherein the main pole and the secondary pole extend upward at an angle between about 1 degree to about 3 degrees from vertical.

3. The adjustable crutch frame of claim 1, wherein an adjustment range between the lower pole and the main pole provides for from about 18 inches to about 24 inches of length adjustment.

4. The adjustable crutch frame of claim 1, further comprising upper adjustment pole receptacles on a top end of the main pole and the secondary pole.

5. The adjustable crutch frame of claim 4, further comprising upper adjustment poles telescopingly extending from the upper adjustment pole receptacles.

6. The adjustable crutch frame of claim 5, further comprising an axilla support disposed at ends of the upper adjustment poles.

7. The adjustable crutch frame of claim 5, wherein the main pole, the secondary pole and the upper adjustment poles extend upward at an angle between about 1 degree to about 3 degrees from vertical.

8. The adjustable crutch frame of claim 1, further comprising an axilla support disposed at ends of the main pole and the secondary pole.

9. The adjustable crutch frame of claim 1, further comprising a placard secured between the main pole and the secondary pole.

10. The adjustable crutch frame of claim 1, further comprising a handgrip placed on at least one of the main pole and the secondary pole, the handgrip serving as a handle for a user moving between a standing position and a seated position.

11. The adjustable crutch frame of claim 1, further comprising at least one strap for securing a pair of the adjustable crutch frames together.

12. The adjustable crutch frame of claim 1, further comprising a cuff crutch pole having an arm cuff removably attached to the main pole.

13. An adjustable crutch frame comprising:
a main pole having a lower adjustment pole receptacle and an upper adjustment pole receptacle;
a secondary pole attached to and extending from the main pole, the secondary pole having a secondary pole upper adjustment pole receptacle;
a grip disposed between the main pole and the secondary pole;
a lower pole telescopingly extending from the main pole; and
upper adjustment poles telescopingly extending from each of the upper adjustment pole receptacle and the secondary pole upper adjustment pole receptacle, wherein
the main pole extends linearly upward from the grip at an angle outward relative a vertical axis extending through the grip.

14. The adjustable crutch frame of claim 13, wherein the main pole, the secondary pole and the upper adjustment poles extend upward at an angle between about 1 degree to about 3 degrees from vertical between a grip disposed between the main pole and the secondary pole and an axilla support disposed on the upper adjustment poles.

15. The adjustable crutch frame of claim 13, further comprising a handgrip placed on at least one of the main pole and the secondary pole, the handgrip serving as a handle for a user moving between a standing position and a seated position.

16. A mobility aid device that converts between a forearm cuff crutch and a cane comprising:
a cuff support apparatus having a cuff and a cuff support extending from the cuff;
a main pole providing an attachment point for removably attaching the cuff support, the main pole further having a lower receptacle;
a foot pole telescopingly extending from the lower receptacle of the main pole; and
a grip attached to the main pole, wherein
the main pole extends linearly upward from the grip at an angle outward relative a vertical axis extending through the grip.

17. The mobility aid device of claim 16, further comprising a secondary pole having a first end attaching to the main pole and a second end attaching to the grip.

18. The mobility aid device of claim 16, wherein the grip is an ergonomically shaped grip.

19. The mobility device aid of claim 16, further comprising a foot attached to a distal end of the foot pole, wherein the foot articulates, allowing for rotation thereof.
